(19) United States
(12) Patent Application Publication
(10) Pub. No.: US 2026/0164488 A1
(43) Pub. Date: Jun. 11, 2026

(54) CSI Feedback Reduction Methods With Multi-User Interference Coordination In Multi-AP Systems In Wireless Communications

(71) Applicant: MediaTek Inc., Hsinchu City (TW)

(72) Inventors: Samat Shabdanov, San Jose, CA (US); Shuling Feng, San Jose, CA (US); Chung-Ta Ku, San Jose, CA (US); Weisung Tsao, San Jose, CA (US); Po-Yuen Cheng, San Jose, CA (US)

(73) Assignee: MediaTek Inc., Hsinchu City (TW)

(21) Appl. No.: 19/408,409

(22) Filed: Dec. 4, 2025

Related U.S. Application Data
(60) Provisional application No. 63/730,040, filed on Dec. 10, 2024.

(51) Int. Cl. H04W 76/15; H04L 5/00

(52) U.S. Cl. CPC H04W 76/15; H04L 5/0051; H04L 5/0094

(57) ABSTRACT

Techniques pertaining to channel state information (CSI) feedback reduction methods with multi-user (MU) interference coordination in multi-access point (multi-AP) systems in wireless communications are described. An apparatus, as a first AP in a multi-AP system, communicates with a first station (STA) associated with the first AP and a second AP with which a second STA is associated. The apparatus performs one or more coordinated operations with the second AP to reduce CSI feedback overhead. The first AP is the first STA's direct AP and the second STA's interfering AP. The second AP is the second STA's direct AP and the first STA's interfering AP. The one or more operations involve at least one of: (a) utilizing uneven sounding intervals at the interfering APs; (b) utilizing uneven fixed subcarrier (SC) grouping at the interfering APs; and (c) utilizing adaptive SC grouping.

### CROSS REFERENCE TO RELATED PATENT APPLICATION

The present disclosure is part of a non-provisional patent application claiming the priority benefit of U.S. Provisional Patent Application No. 63/730,040, filed 10 Dec. 2024, the content of which herein being incorporated by reference in its entirety.

### TECHNICAL FIELD

The present disclosure is generally related to wireless communications and, more particularly, to channel state information (CSI) feedback reduction methods with multi-user (MU) interference coordination in multi-access point (multi-AP) systems in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) and wireless local area networks (WLANs) under the Institute of Electrical and Electronics Engineers (IEEE) 802.11 standards, a potential application of multi-AP (herein interchangeably referred to as “MAP”) systems may be the use of MU beamforming (BF) schemes such as coordinated beamforming (CBF). To obtain precoding techniques, accurate CSI of all the stations (STAs) in the multi-AP basic service set (BSS) is required, as knowledge of CSI is necessary to compute steering precoding matrix. The CSI is obtained using channel sounding. Additionally, MAP enables access points (APs) to coordinate the amount of residual MU interference. In MAP, a “direct AP” of a STA denotes an AP that has data to transmit to that STA, whereas an “interfering AP” denotes an AP that creates interference to that STA. (Thus, a direct AP for one STA may be an interfering AP for another STA, and vice versa.) The overhead of channel acquisition at the transmitters and the amount of feedback to support MAP-based BF schemes can be very large. The length of the feedback depends on the number of spatial streams, size of BF matrix Nᵣ×N_{c}, bandwidth, subcarrier (SC) grouping size N_{g} and codebook information. The latter includes the number of angles and quantization resolution.

While both explicit and implicit channel sounding are defined in IEEE 802.11 specification, the former is commonly used in practice and supported in the latest IEEE 802.11 standards. With explicit sounding, a beamformer initiates the sounding protocol and announces a beamformee to measure the channel and to feedback to the beamformer the quantized estimate of the channel. Despite that there are a few common methods to reduce CSI applicable to explicit sounding (e.g., a feedback being sent for a group of SCs of a fixed length N_{g}, sending the feedback for a group of resource units using partial bandwidth, the feedback carrying signal-to-noise ratios (SNRs) rather than quantized channel, and other methods based on using codebook-based feedback, differential rotation, and variable quantization), such methods tend to suffer from large sounding overheads when used with MU BF schemes.

Thus, the amount of CSI feedback can be very large, and this may pose a major challenge to CBF in MAP networks. The CSI overhead increases linearly with the number of SCs, spatial streams (SSs), STAs and the size of MAP. It is anticipated that the future generations of IEEE 802.11 APs may support greater than 16 spatial streams and large MU groups. When the compressed CSI reports are very long, not only a lower throughput rate may result but also a challenge to multiplexing long frames in the uplink (UL) aggregate medium access control (MAC) protocol data units (AMPDUs) using MU multiple-input-multiple-output (MIMO) or orthogonal frequency-division multiple-access (OFDMA) may result. For example, when the CSI frame report exceeds 11454 bytes, the report needs to be split in eight segments and sent in a single AMPDU carried in a physical-layer (PHY) protocol data unit (PPDU). Additionally, the duration of feedbacks tends to be constrained by the maximum PPDU duration of 5.4 milliseconds (ms), and the transmission opportunity (TXOP) duration is limited by the Length field in legacy-signal field (L-SIG) that can support the maximum duration corresponding to 4095 octets at 6 million bits per second (mbps).

Therefore, there is a need for a solution of CSI feedback reduction methods with MU interference coordination in multi-AP systems in wireless communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods, and apparatuses pertaining to CSI feedback reduction methods with MU interference coordination in multi-AP systems in wireless communications. It is believed that implementation of one or more schemes proposed herein may address or otherwise alleviate the aforementioned issue(s). Under various proposed schemes in accordance with the present disclosure, one or more methods may be utilized to reduce CSI feedback with MU interference coordination in multi-AP systems. For instance, one method may involve uneven sounding intervals at interfering APs. Another method may involve uneven fixed SC grouping at interfering APs. Still another method may involve adaptive SC grouping.

In one aspect, a method may involve a first AP, in a multi-AP system, communicates with a first STA associated with the first AP and a second AP with which a second STA is associated. The method may also involve the first AP performing one or more coordinated operations with the second AP to reduce CSI feedback overhead. The first AP may be the first STA's direct AP and the second STA's interfering AP. The second AP may be the second STA's direct AP and the first STA's interfering AP. The one or more operations may involve at least one of: (a) utilizing uneven sounding intervals at the interfering APs; (b) utilizing uneven fixed SC grouping at the interfering APs; and (c) utilizing adaptive SC grouping.

In another aspect, a method may involve a first STA associated with a first AP communicating with the first AP in a MAP system including the first AP and a second AP with which a second STA is associated. The method may also involve the first STA participating in one or more coordinated operations with at least the first AP to reduce CSI feedback overhead. The first AP may be the first STA's direct AP and the second STA's interfering AP. The second AP may be the second STA's direct AP and the first STA's interfering AP. The one or more operations may involve at least one of: (a) utilizing uneven sounding intervals at the interfering APs; (b) utilizing uneven fixed SC grouping at the interfering APs; and (c) utilizing adaptive SC grouping.

It is noteworthy that, although the description provided herein may be in the context of certain radio access technologies, networks and network topologies such as Wi-Fi/WiFi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example scenario of a MAP with CBF.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example algorithm under a proposed scheme in accordance with the present disclosure.

FIG. 9 is a block diagram of an example communication system under a proposed scheme in accordance with the present disclosure.

FIG. 10 is a flowchart of an example process under a proposed scheme in accordance with the present disclosure.

FIG. 11 is a flowchart of an example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to CSI feedback reduction methods with MU interference coordination in multi-AP systems in wireless communications. According to the present disclosure, a number of possible solutions may be implemented separately or jointly. That is, although these possible solutions may be described below separately, two or more of these possible solutions may be implemented in one combination or another. The various solutions and schemes implement the proposed schemes between APs and non-AP STAs. Accordingly, the various solutions and schemes proposed herein may address or otherwise alleviate the issues described above.

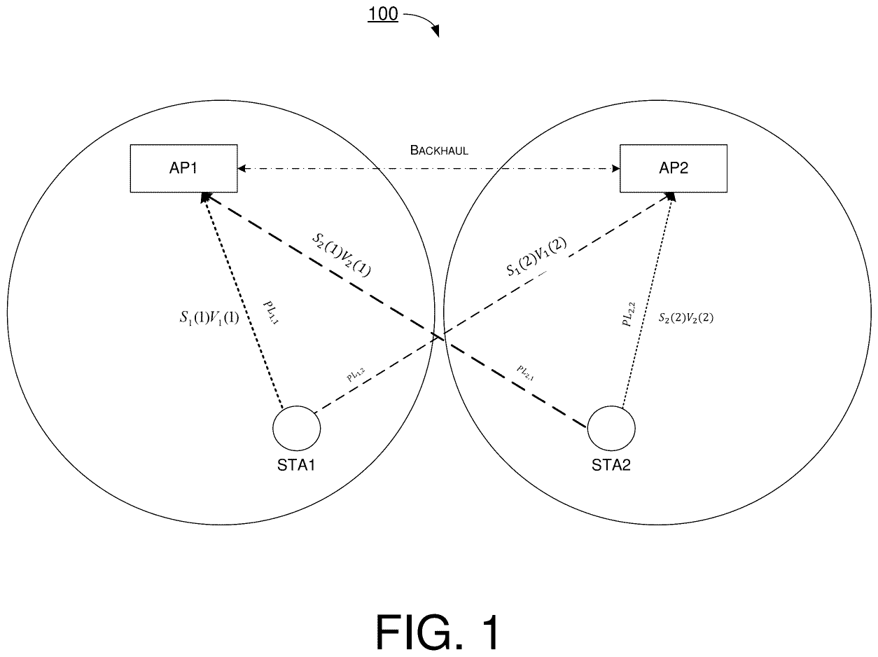

FIG. 1 illustrates an example scenario 100 of a MAP with CBF. Referring to FIG. 1, the direct channels in scenario 100 are between AP1 and STA1, as well as between AP2 and STA2. The interfering channels are between AP1 and STA2, as well as between AP2 and STA1. When the interfering APs are located at a further distance from a STA than the STA's direct AP, it is expected that

$${PL}_{i}^{′} > {PL}_{i}$$

for any given STA, with PL denoting path loss. The further the interfering AP is located from the STA, the higher is the value of

$${PL}_{i}^{′} ,$$

consequently it results in a smaller factor of MU interference

$${\sum }_{i \neq k}^{K} \frac{1}{{PL}_{i}^{′}} {H}_{i}^{′} {W}_{i} .$$

This means that the distance between the interfering AP and the STA helps in lessening the impact of the residual MU interference. In this case, the amount of the feedback may be reduced by allowing a longer sounding interval and larger SC grouping at interfering APs.

A common method for reduction of CSI overhead is to group several contiguous SCs in a group of fixed size of N_{g} SCs that share the same CSI. Typically, grouping sizes N_{g} are 4 or 16 SCs. While the fixed SC grouping method can reduce the CSI overhead by a factor of (N_{g}−1)/N_{g}, this method does not exploit statistical properties of the channel as well as an impact of path loss on residual MU interference. When the parameters of CSI feedback are chosen to reduce CSI aggressively, higher MU residual interference may result. Consequently, transmitted frames might not be decoded successfully. Hence, there is a need for a mechanism to coordinate the amount of residual MU interference.

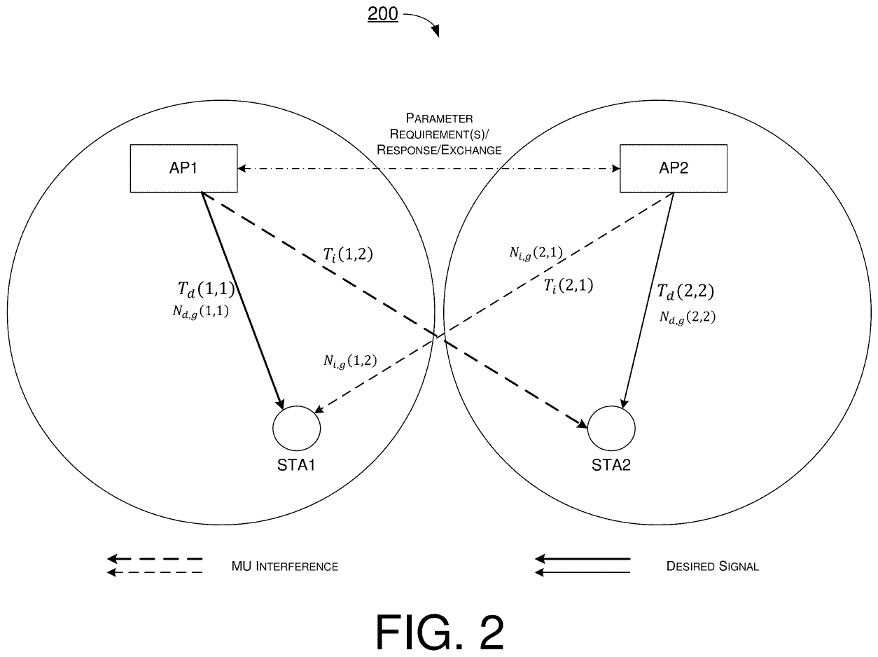

FIG. 2 illustrates an example scenario 200 under a proposed scheme in accordance with the present disclosure with respect to channel sounding and CSI feedback overhead reduction in WiFi systems with MAP. Under the proposed scheme, there may be three different methods to be used individually or in any combination to reduce CSI feedback overhead, hereinafter referred to as “Method 1”, “Method 2” and “Method 3”. Method 1 may pertain to uneven sounding intervals at interfering APs, and Method 1 may enable interfering APs to have different and longer sounding intervals than the one(s) used at direct AP(s). Method 2 may pertain to uneven fixed SC grouping at interfering APs, and Method 2 may enable interfering APs to have different and larger SC grouping size than the one(s) used at direct AP(s). Method 3 may pertain to adaptive SC grouping, and Method 3 may utilize inter-SC correlation coefficients by using adaptive SC grouping (A-SCG). A-SCG may select several contiguous SCs that are closely correlated and therefore can be represented by the same CSI. The size of a feedback group is not fixed and needs to be adaptively determined by A-SCG. Such an adaptive grouping may allow a beamformee to compress CSI feedback more efficiently compared with fixed grouping method(s). Besides, with reduction in feedback overhead, A-SCG may improve accuracy of CSI. Thus, the mechanism under Method 3 may involve a SC grouping algorithm and minor configuration changes to the sounding protocol and control frames.

Under Method 1, uneven sounding intervals may be utilized at interfering APs. Accordingly, the sounding intervals on interfering channels via cooperation between AP1 and AP2 may be increased so that Tᵢ≥T_{d}, with T_{d} and Tᵢ denoting the sounding interval at its own direct AP and sounding interval at its interfering AP, respectively. Under a second proposed scheme in accordance with the present disclosure (hereinafter interchangeably referred to as “Method 2”), uneven fixed SC grouping may be utilized at interfering APs. Accordingly, with inter-AP cooperation (e.g., between AP1 and AP2), the SC grouping size on interfering channels may be adjusted to be larger than the SC grouping on desired direct channels. In FIG. 2, N_{d,g} and N_{i,g} denote the SC size used on direct desirable channels and interfering channels, respectively. Under a third proposed scheme in accordance with the present disclosure (hereinafter interchangeably referred to as “Method 3”), adaptive SC grouping may be utilized. Accordingly, the SC grouping size on interfering channels may be adapted to the varying channel conditions.

Both Method 1 and Method 2 may be based on utilizing the mitigation property of path loss on residual MU interference. The received signal at STA k per SC may be expressed as

$${y}_{k} = \frac{1}{{PL}_{k}} {H}_{k} {W}_{k} {x}_{k} + {\sum }_{i \neq k}^{K} \frac{1}{{PL}_{i}^{′}} {H}_{i}^{′} {W}_{i} {x}_{i} ,$$

with the first term denoting the desired signal and the second term denoting the MU interference. In the expression, Wᵢ denotes the precoding matrix for user i, PLᵢ and

$${PL}_{i}^{′}$$

denote the pain losses between STA i and the direct AP and the interfering AP, respectively. Similarly, Hₖ and

$${H}_{i}^{′}$$

express the channels between STA i and the direct AP and the interfering AP, respectively. In practice, the second term may not be perfectly zero due to channel aging. Specifically, the second term,

$${N}_{MU , I} ( k ) = {\sum }_{i \neq k}^{K} \frac{1}{{PL}_{i}^{′}} {H}_{i}^{′} {W}_{i} ,$$

is the residual MU interference. The precoder Wᵢ may be designed for zero and partial interference nulling (e.g., N_{MU,I}(k)≠0). This term depends on channel aging as well as on the amount of CSI feedback.

Method 3 uses the fact that a wideband channel is unevenly correlated and the sequence of highly correlated SCs vary in length. Typical 2.4 GHz and 5 GHz indoor channels are characterized as channels in the rich scatterings with high spatial correlation between SCs across a wide bandwidth. The use of fixed length of SC grouping does not effectively utilize SC properties of the channel. Accordingly, under Method 3, CSI feedback may be compressed by utilizing spatial correlation between contiguous SCs with adaptable SC grouping. It is noteworthy that, Method 1, Method 2 and Method 3 may act as supplementary methods/techniques in various implementation scenarios in CSI reduction. Moreover, the present disclosure proposes an interference coordination mechanism for APs to adjust their parameters so that STAs do not suffer from poor throughput. This mechanism may be used jointly with CSI feedback reduction Method 1, Method 2 and/or Method 3.

Under the proposed scheme, the CSI reduction methods may operate by adjusting certain parameters including T_{d}(i,j) and Tᵢ(i,j), which denote the sounding intervals between APᵢ and STAⱼ corresponding to the direct and interfering channels. Moreover, N_{d,g}(i,j) and N_{i,g}(i,j) denote the fixed SC grouping at APᵢ and STAⱼ, and γ_{threshold} denotes the signal-to-noise ratio (SNR) threshold for adaptive SC.

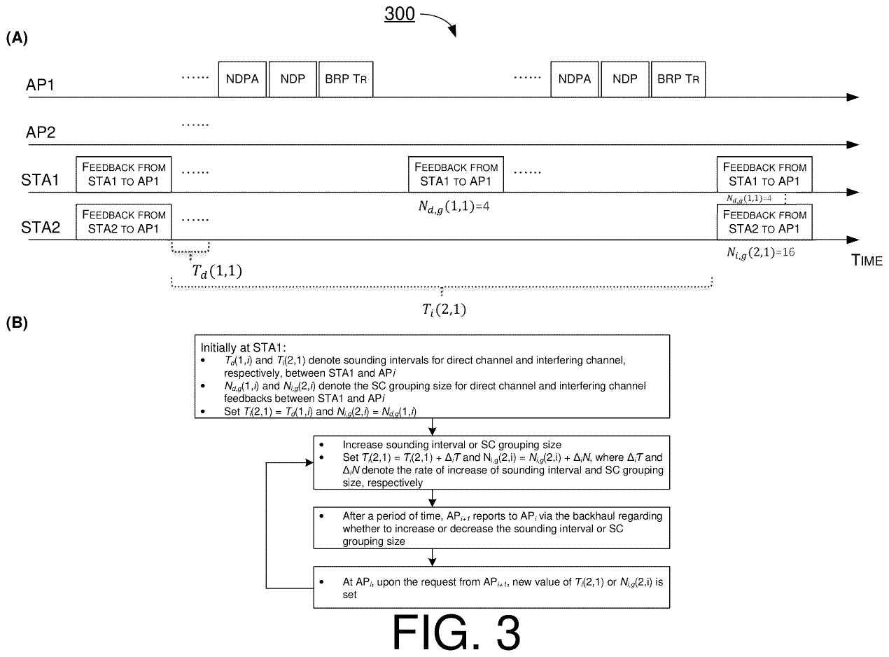

FIG. 3 illustrates an example scenario 300 under a proposed scheme in accordance with the present disclosure. Scenario 300 may pertain to a first implementation scenario (Embodiment 1). In MAP with CBF, the channel sounding is required to obtain S and V matrices between each AP in the MAP and all STAs. The feedbacks carry Sᵢ(j) and Vᵢ(j) for each subcarrier between the i^{th} STA and the j^{th} AP in the MAP. To perform CBF precoding, each AP requires the knowledge of CSI between the AP and all the STAs in a MAP network. Since the path losses of interfering channels is larger than the path loss of a direct channel (e.g., the residual MU interference is mitigated by the larger PL), channel sounding intervals T and SC grouping size N_{g} of direct channels and interfering channels may be characterized differently under the proposed scheme. Specifically, the interfering channels may have a longer sounding interval and a larger SC grouping size (compared to those of a direct channel). As a result, the size of CSI feedback may be reduced without jeopardizing system throughput.

For the exemplary MAP, with Method 1, part (A) of FIG. 3 shows the sounding interval for direct channels, T_{d}(1,1), between STA1 and AP1 and interfering channels, Tᵢ(2,1), between STA1 and AP2. With Method 2, at APs, different fixed SC grouping for direct N_{d,g}(1,1) and interfering N_{i,g}(2,1) channels may be set. The original IEEE 802.11 standard does not allow the configuration of SC grouping parameter N_{g} per STA. Under the proposed scheme, the reserved bits B29˜B31 in a null data packet announcement (NDPA) and bits B34˜B39 of Extremely-High-Throughput (EHT) MIMO control field may be used to indicate the N_{g} group per STA. Part (B) of FIG. 3 shows an example algorithm executed at an APᵢ for coordinated configuration of interfering channel sounding interval and SC grouping size.

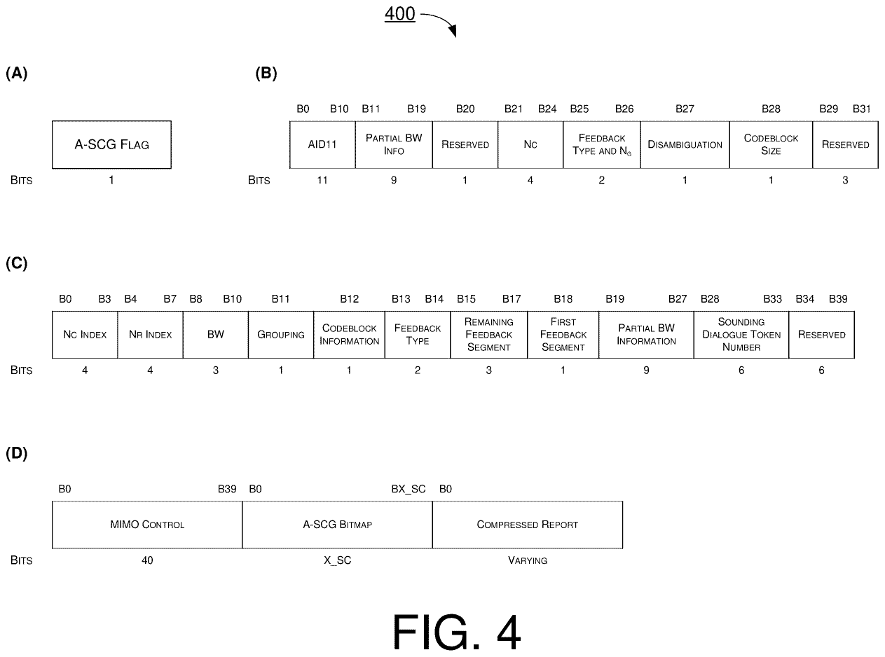

FIG. 4 illustrates an example scenario 400 under a proposed scheme in accordance with the present disclosure. Scenario 400 may pertain to a second implementation scenario (Embodiment 2). In Embodiment 2, each AP in a MAP may announce its A-SCG capability by setting an A-SCG flag shown in part (A) of FIG. 4. This 1-bit flat may serve to indicate whether or not the A-SCG capability is enabled. The APs in the MAP may set the A-SCG flag only for those STAs that are selected for activation of this capability. Additionally, an A-SCG subfield flag may be allocated in the Per STA Info field of the NDPA frame. In IEEE 802.11, the STA Info field in the NDPA frame has the format shown in part (B) of FIG. 4. Under the proposed scheme, any bit from the reserved bit B20 and B29˜B31 may be utilized for use as the A-SCG flag subfield in the NDPA frame.

When a STA receives an NDPA with its A-SCG flag being set, the STA may decide whether to enable A-SCG or to use a conventional CSI feedback. In case that a STA decides to enable A-SCG, the STA may need to inform its associated AP by setting the A-SCG flag in the compressed beamforming action frame. In IEEE 802.11, the EHT MIMO Control field has the format shown in part (C) of FIG. 4. Under the proposed scheme, a bit from the reserved bits B34˜B39 of the EHT MIMO Control field may be used as the A-SCG flag by a STA to indicate to the AP that CSI report from the STA is encoded using A-SCG.

For an AP to be able to reconstruct all the per-SC CSIs (e.g., all the V matrices per SC), the compressed beamforming frame needs to be include an A-SCG bitmap field in the first X-SC bits of the compressed BF report field. Here, “X-SC” denotes the size of the A-SCG bitmap field which depends on the value of bandwidth in the MIMO Control field. Referring to part (D) of FIG. 4, each bit in the A-SCG bitmap may represent a respective SC, and the position of a bit in the bitmap may represent the SC number. The compressed BF report field may not change its configuration and may carry compressed CSI according to the IEEE 802.11 standard.

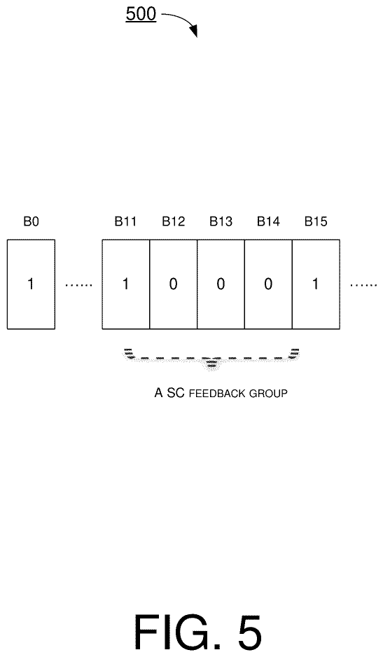

FIG. 5 illustrates an example scenario 500 under a proposed scheme in accordance with the present disclosure. Scenario 500 may pertain to a third implementation scenario (Embodiment 3). FIG. 5 shows an example A-SCG Bitmap field. In Embodiment 3, encoding of bits in the A-SCG bitmap may be performed as described below. In case that a bit is set to 0 then the corresponding SC belongs to a SC group starting with the first non-zero element to the left from the current bit position. All the SCs in the group may share the same CSI (e.g., V matrix) that is computed for the first non-zero element in the SC group. Alternatively, in case that a bit is set to 1 then the CSI (e.g., V matrix) for the SC may be computed and represented in the beamforming report field. This SC may serve as a start of a SC feedback group. Alternatively, the first bit of the A-SCG bitmap may be always set to 1.

As an example, in Embodiment 3, CSIs (e.g., V matrices) for SC1 (represented by bit B0), SC12 (represented by bit B11) and SC16 (represented by bit B15) may be reported in the BF report frame while the CSIs for SC13 (represented by bit B12), SC14 (represented by bit B13) and SC15 (represented by bit B14) may not be reported since these three SCs belong to the same feedback group. Accordingly, the AP may reconstruct CSIs corresponding to SC13, SC14 and SC15 by using the CSI (e.g., V matrix) of SC12 represented in the BF report field.

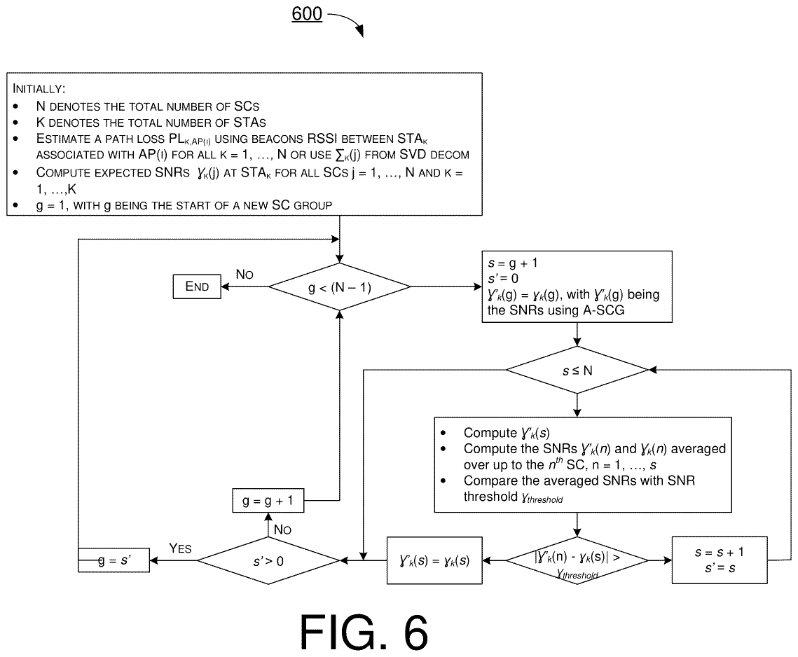

FIG. 6 illustrates an example scenario 600 under a proposed scheme in accordance with the present disclosure. Scenario 600 may pertain to a fourth implementation scenario (Embodiment 4). FIG. 6 shows an example algorithm of SC grouping of Embodiment 4. Under the proposed scheme, the effectiveness of A-SCG depends on a SC grouping algorithm. The protocol enhancements specify only the rules on how to compress and reconstruct CSIs whereas the SC algorithm itself is a design choice of STAs. The main challenge on designing the algorithm may be to find a model to incorporate inter-SC correlation coefficients into the per-SC signal-to-interference-and-noise ratio (SINR) and decision thresholds to decide whether or not to group a given SC. The requirement for this algorithm is to provide CSI overhead reduction while not degrading performance. Under the proposed scheme, an SC grouping algorithm may rely on the following properties of IEEE 802.11: (1) modulation and coding scheme (MCS) selection may be limited to the same MCS on each spatial stream (SS); and (2) for all the SCs in a given resource unit (RU). This property may imply that on downlink (DL) the MCS selection may be characterized by an SINR estimate averaged across all the SCs and SSs. While STAs may use their own grouping, the SC grouping algorithm under the proposed scheme may provide a feasibility study of the adaptive feedback reduction mechanism.

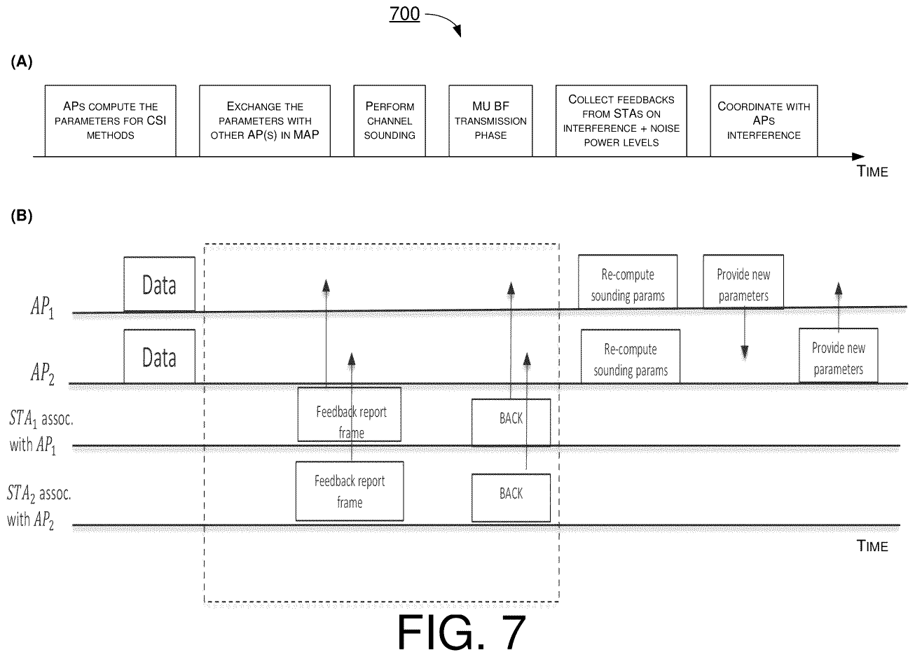

FIG. 7 illustrates an example scenario 700 under a proposed scheme in accordance with the present disclosure. Scenario 700 may pertain to a fifth implementation scenario (Embodiment 5). FIG. 7 shows an example procedure of Embodiment 5. Under the proposed scheme, the parameters for CSI, method 1, method 2, and method 3 methods may be selected by each AP for each STA that is associated with the respective AP. Referring to part (A) and part (B) of FIG. 7, firstly, using algorithm(s) under the proposed scheme, an AP may compute the sounding parameters using either partial or zero interference nulling precoding. The parameters may be exchanged with the interfering APs. The STAs may report measured powers of noise plus interference back to associated APs. This may be accomplished using a specialized coordinated feedback frame or utilizing the reserved fields in a block acknowledgement (Block ACK). The acknowledgements (ACKs) may be collected to characterize the target packet error rate (PER) and reported to the APs performing sounding, and the APs may re-compute the sounding parameters if necessary.

Under the proposed scheme, a STA may permit a certain increase of noise+interference power per selected MCS. However, when the level of noise+interference power exceeds a certain threshold, the STA may send a feedback to the AP(s) asking to keep the interference level below the desired threshold. In the feedback report, the STA may characterize the amount of interference by using the channel interference quality (CIQ) metric ΔN (i,j). The CIQ may represent multiple (e.g., 10) levels as expressed as follows:

$$Δ N ( i , j ) = ⌊ \frac{\vert {N}_{MU , I} ( i , j ) - {N}_{th} ( i , j ) \vert}{{N}_{th} ( i , j )} ⌋ .$$

In the expression, └x┘ denotes the rounding operation after the decimal point, N_{MU,I}(i,j) denotes the amount of noise+interference power level between APⱼ and STAᵢ, and Nₜₕ(i,j) denotes the noise per MCS threshold for STAᵢ. Here, N_{MU,I}(i,j) may be obtained by averaging across the noise powers across all the SCs used for CBF operation.

Under the proposed scheme, the feedback may use 2 bits to characterize the CIQ. The feedback may be conveyed either by using a feedback frame or the reserved field of a Block ACK (BA) frame, as shown in part (B) of FIG. 7. For instance, reserved bits B3˜B11 in the BA control field may be sufficient to carry CIQ feedback to APs. Correspondingly, with CIQ, the APs may decide whether the interfering AP(s) ought to employ aggressive sounding parameters. The BA may be transmitted by STAs on separate RUs. Prior to the CBF data transmission, the values of Nₜₕ(i,j) may be delivered to STAs or these values may be known in advance both by the STAs and the APs.

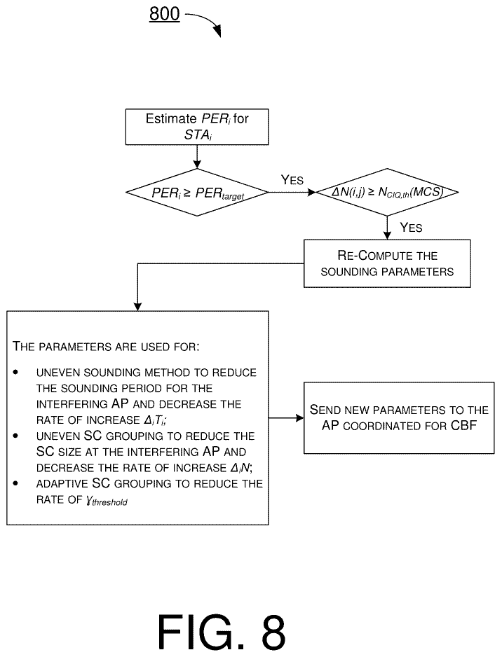

FIG. 8 illustrates an example algorithm 800 under a proposed scheme in accordance with the present disclosure. Algorithm 800 may pertain to a multi-AP coordination framework of Embodiment 5. Referring to FIG. 8, an AP may utilize Block ACK to estimate the target PER (PER_{target}) threshold. In practice, typically the value of target PER may be PER_{target}=10%. When the ACKs are not received at an AP, it may indicate that the frames are lost. This may occur for various reasons but having the PER estimates along the i^{th} SC. An AP; may execute algorithm 800 as shown in FIG. 8. In case that APⱼ determines that PER is greater than the target PER and the channel CIQ exceeds the threshold value N_{CIQ,th}(MCS) per selected MCS, then APⱼ may need to re-compute the sounding parameters. Such parameters may be utilized, for: (a) uneven sounding method to reduce the sounding period for the interfering AP and decrease the rate of increase, ΔᵢT; (b) uneven SC grouping method to reduce the SC size at the interfering AP and decrease the rate of increase, ΔᵢN; and (c) adaptive SC grouping method to reduce the rate of γ_{threshold}. The parameterization of N_{CIQ,th}(MCS) may be a practical realization either via algorithmic approach or using simulations to find predetermined values per MCS and RU. In some cases, it may be possible that the selected parameters may be very aggressive and may render STA(s) unable to decode the data frames.

### ILLUSTRATIVE IMPLEMENTATIONS

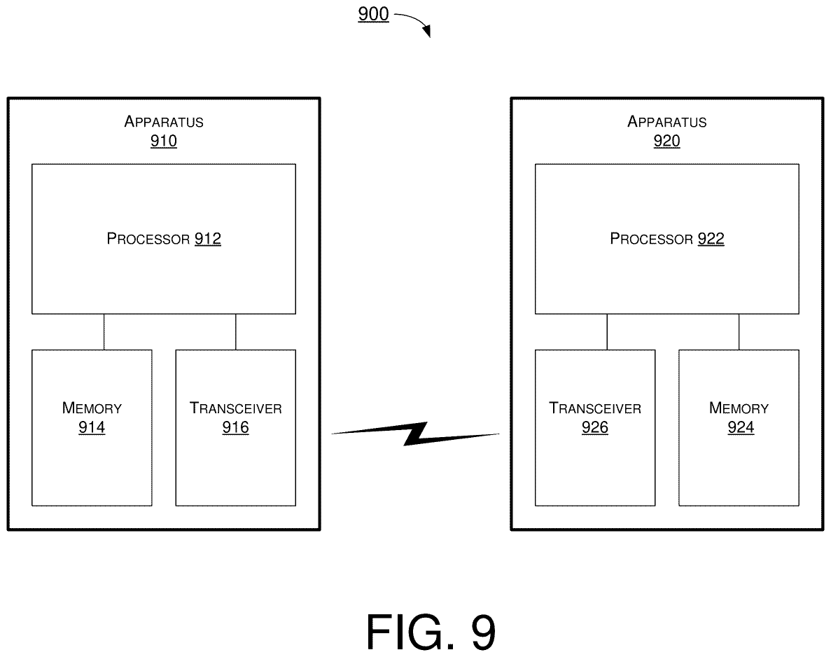

FIG. 9 illustrates an example system 900 having at least an example apparatus 910 and an example apparatus 920 in accordance with an implementation of the present disclosure. Each of apparatus 910 and apparatus 920 may perform various functions to implement schemes, techniques, processes, and methods described herein pertaining to CSI feedback reduction methods with MU interference coordination in multi-AP systems in wireless communications, including the various schemes described above with respect to various proposed designs, concepts, schemes, systems and methods described above as well as processes described below. For instance, apparatus 910 may be implemented in a first AP (e.g., AP1) and apparatus 920 may be implemented in a second AP (e.g., AP2), or vice versa.

Each of apparatus 910 and apparatus 920 may be a part of an electronic apparatus, such as a portable or mobile apparatus, a wearable apparatus, a wireless communication apparatus or a computing apparatus. When implemented in a STA, each of apparatus 910 and apparatus 920 may be implemented in a smartphone, a smart watch, a personal digital assistant, a digital camera, or a computing equipment such as a tablet computer, a laptop computer or a notebook computer. Each of apparatus 910 and apparatus 920 may also be a part of a machine type apparatus, which may be an IoT apparatus such as an immobile or a stationary apparatus, a home apparatus, a wire communication apparatus or a computing apparatus. For instance, each of apparatus 910 and apparatus 920 may be implemented in a smart thermostat, a smart fridge, a smart door lock, a wireless speaker, or a home control center. When implemented in or as a network apparatus, apparatus 910 and/or apparatus 920 may be implemented in a network node, such as an AP in a WLAN or a mesh device.

In some implementations, each of apparatus 910 and apparatus 920 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 910 and apparatus 920 may be implemented in or as a STA or an AP. Each of apparatus 910 and apparatus 920 may include at least some of those components shown in FIG. 9 such as a processor 912 and a processor 922, respectively, for example. Each of apparatus 910 and apparatus 920 may further include one or more other components not pertinent to the proposed scheme of the present disclosure (e.g., internal power supply, display device and/or user interface device), and, thus, such component(s) of apparatus 910 and apparatus 920 are neither shown in FIG. 9 nor described below in the interest of simplicity and brevity.

In one aspect, each of processor 912 and processor 922 may be implemented in the form of one or more single-core processors, one or more multi-core processors, one or more RISC processors or one or more CISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including those pertaining to CSI feedback reduction methods with MU interference coordination in multi-AP systems in wireless communications in accordance with various implementations of the present disclosure.

In some implementations, apparatus 910 may also include a transceiver 916 coupled to processor 912. Transceiver 916 may include a transmitter capable of wirelessly transmitting and a receiver capable of wirelessly receiving data. In some implementations, apparatus 920 may also include a transceiver 926 coupled to processor 922. Transceiver 926 may include a transmitter capable of wirelessly transmitting and a receiver capable of wirelessly receiving data. It is noteworthy that, although transceiver 916 and transceiver 926 are illustrated as being external to and separate from processor 912 and processor 922, respectively, in some implementations, transceiver 916 may be an integral part of processor 912 as a system on chip (SoC) and/or transceiver 926 may be an integral part of processor 922 as a SoC.

In some implementations, apparatus 910 may further include a memory 914 coupled to processor 912 and capable of being accessed by processor 912 and storing data therein. In some implementations, apparatus 920 may further include a memory 924 coupled to processor 922 and capable of being accessed by processor 922 and storing data therein. Each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read-only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random-access memory (NVRAM) such as flash memory, solid-state memory, ferroelectric RAM (FeRAM), magnetoresistive RAM (MRAM) and/or phase-change memory.

Each of apparatus 910 and apparatus 920 may be a communication entity capable of communicating with each other using various proposed schemes in accordance with the present disclosure. For illustrative purposes and without limitation, a description of the capabilities of apparatus 910 and apparatus 920, functioning as a coordinating/sharing AP and a coordinated/shared AP, respectively, is provided below in the context of example processes 1000 and 1100. It is noteworthy that, although a detailed description of capabilities, functionalities and/or technical features of either of apparatus 910 and apparatus 920 is provided below, the same may be applied to the other of apparatus 910 and apparatus 920 although a detailed description thereof is not provided solely in the interest of brevity. It is also noteworthy that, although the example implementations described below are provided in the context of WLAN, the same may be implemented in other types of networks.

### ILLUSTRATIVE PROCESSES

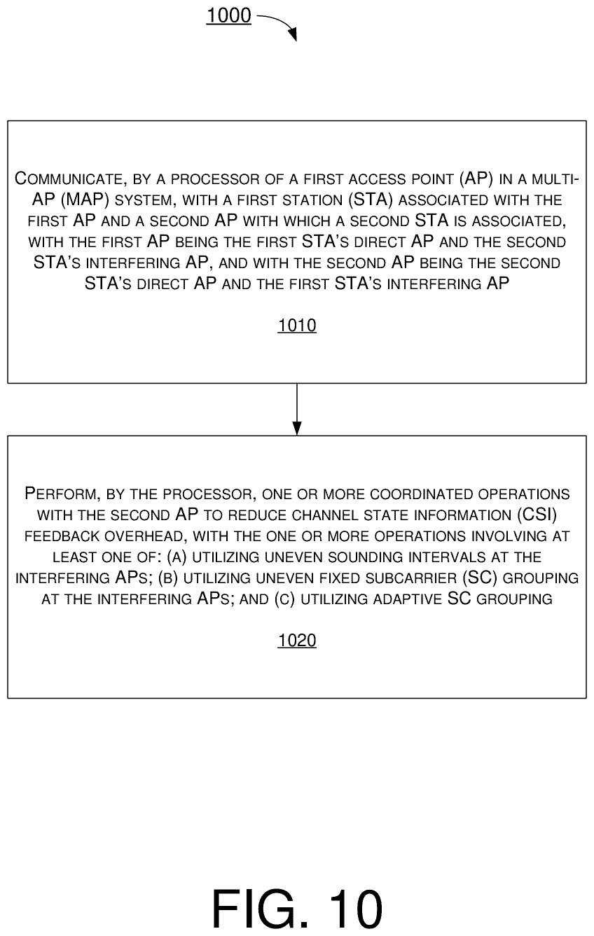

FIG. 10 illustrates an example process 1000 in accordance with an implementation of the present disclosure. Process 1000 may represent an aspect of implementing various proposed designs, concepts, schemes, systems, and methods described above. More specifically, process 1000 may represent an aspect of the proposed concepts and schemes pertaining to CSI feedback reduction methods with MU interference coordination in multi-AP systems in wireless communications. Process 1000 may include one or more operations, actions, or functions as illustrated by one or more of blocks. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Furthermore, one or more of the blocks/sub-blocks of process 1000 may be executed repeatedly or iteratively. Process 1000 may be implemented by or in apparatus 910 and apparatus 920 as well as any variations thereof. Solely for illustrative purposes and without limiting the scope, process 1000 is described below in the context of apparatus 910 and apparatus 920 implemented in or as a first AP (e.g., AP1) and a second AP (e.g., AP2) or a first STA (e.g., STA1), respectively, in a wireless network such as a WLAN in accordance with one or more of IEEE 802.11 standards. Process 1000 may begin at block 1010.

At 1010, process 1000 may involve processor 912 of apparatus 910, as a first AP in a MAP system, communicating, via transceiver 916, with a first STA associated with the first AP and a second AP with which a second STA is associated. The first AP is the first STA's direct AP and the second STA's interfering AP, and the second AP is the second STA's direct AP and the first STA's interfering AP. Process 1000 may proceed from 1010 to 1020.

At 1020, process 1000 may involve processor 912 performing, via transceiver 916, one or more coordinated operations with the second AP to reduce CSI feedback overhead. The one or more operations involve at least one of: (a) utilizing uneven sounding intervals at the interfering APs; (b) utilizing uneven fixed SC grouping at the interfering APs; and (c) utilizing adaptive SC grouping.

In some implementations: (a) the utilizing of the uneven sounding intervals at the interfering APs may involve each interfering AP utilizing a different and longer sounding interval than that used by each direct AP; (b) the utilizing of the uneven fixed SC grouping at the interfering APs may involve each interfering AP utilizing a different and larger SC grouping size than that used by each direct AP; and (c) the utilizing of the adaptive SC grouping may involve each AP utilizing inter-SC correlation coefficients by using A-SCG to select several contiguous SCs that are correlated sufficiently closely to be represented by a same CSI.

In some implementations, in performing the one or more coordinated operations, process 1000 may involve processor 912 performing certain operations. For instance, process 1000 may involve processor 912 increasing either or both of a sounding interval and a SC grouping size. Additionally, process 1000 may involve processor 912 after a period of time, determining with the second AP about whether or not to increase or decrease the sounding interval or the SC grouping size. Moreover, process 1000 may involve processor 912 setting a new value of either or both of the sounding interval and the SC grouping size as a result of the determining.

In some implementations, in performing the one or more coordinated operations, process 1000 may involve processor 912 transmitting an announcement frame (e.g., NDPA frame) with an indication of whether an A-SCG capability is enabled. For instance, the indication may include one of a plurality of reserved bits in the announcement frame serving as a 1-bit flag to provide the indication.

In some implementations, in performing the one or more coordinated operations, process 1000 may involve processor 912 receiving a compressed beamforming frame from the first STA or the second STA with an A-SCG flag in the compressed beamforming frame indicating that a CSI report is encoded using A-SCG. In some implementations, the compressed beamforming frame may further include an A-SCG Bitmap field of an A-SCG bitmap with each bit in the A-SCG bitmap representing a respective SC and with a position of each bit in the A-SCG bitmap representing a respective SC number. In such cases, the A-SCG bitmap may enable the first AP to reconstruct all per-SC CSIs. For instance, a value of 0 in a bit of the A-SCG bitmap may indicate that a corresponding SC belongs to a SC group starting with a first non-zero element to a left from a current bit position in the A-SCG bitmap, with all SCs in the SC group sharing a same CSI that is computed for the first non-zero element in the SC group. Conversely, a value of 1 in another bit of the A-SCG bitmap may indicate that a corresponding CSI for a respective SC is computed and represented in a beamforming report field, with the respective SC serving as a start of a SC feedback group.

In some implementations, in performing the one or more coordinated operations, process 1000 may involve processor 912 performing certain operations. For instance, process 1000 may involve processor 912 computing one or more sounding parameters for CSI reporting. Also, process 1000 may involve processor 912 exchanging the one or more sounding parameters with the second AP. Moreover, process 1000 may involve processor 912 performing channel sounding. Additionally, process 1000 may involve processor 912 performing a MU BF transmission. Moreover, process 1000 may involve processor 912 collecting feedbacks from the first STA and the second STA regarding noise and interference power levels. Furthermore, process 1000 may involve processor 912 coordinating with the second AP regarding an amount of a residual MU interference.

In some implementations, in computing the one or more sounding parameters, process 1000 may involve processor 912 computing the one or more sounding parameters using partial or zero interference nulling precoding.

In some implementations, in collecting the feedbacks, process 1000 may involve processor 912 receiving a feedback from the first STA or the second STA in a coordinated feedback frame or a reserved field in a response frame (e.g., Block ACK). Alternatively, or additionally, in collecting the feedbacks, process 1000 may involve processor 912 receiving a feedback from the first STA or the second STA characterizing a CIQ.

In some implementations, in performing the one or more coordinated operations, process 1000 may involve processor 912 performing further operations. For instance, process 1000 may involve processor 912 determining, based on the feedbacks, whether a CIQ exceeds a threshold value per selected MCS. Moreover, process 1000 may involve processor 912 re-computing the one or more sounding parameters responsive to a positive result from the determining. Additionally, process 1000 may involve processor 912 providing the re-computed one or more sounding parameters to the second AP to be used in CBF.

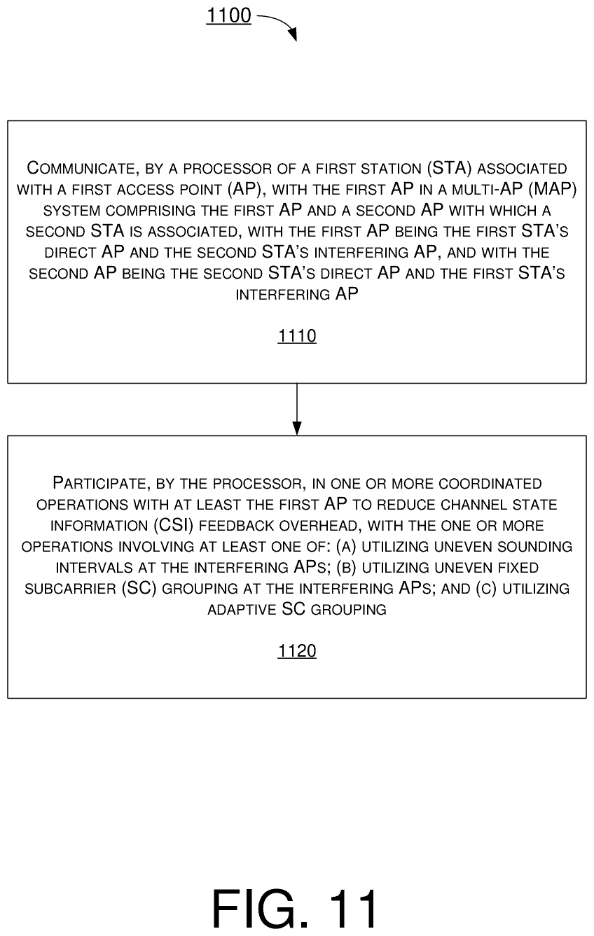

FIG. 11 illustrates an example process 1100 in accordance with an implementation of the present disclosure. Process 1100 may represent an aspect of implementing various proposed designs, concepts, schemes, systems, and methods described above. More specifically, process 1100 may represent an aspect of the proposed concepts and schemes pertaining to CSI feedback reduction methods with MU interference coordination in multi-AP systems in wireless communications. Process 1100 may include one or more operations, actions, or functions as illustrated by one or more of blocks. Although illustrated as discrete blocks, various blocks of process 1100 may be divided into additional blocks, combined into fewer blocks, or eliminated, depending on the desired implementation. Moreover, the blocks/sub-blocks of process 1100 may be executed in the order shown in FIG. 11 or, alternatively, in a different order. Furthermore, one or more of the blocks/sub-blocks of process 1100 may be executed repeatedly or iteratively. Process 1100 may be implemented by or in apparatus 910 and apparatus 920 as well as any variations thereof. Solely for illustrative purposes and without limiting the scope, process 1100 is described below in the context of apparatus 910 and apparatus 920 implemented in or as a first AP (e.g., AP1) and a second AP (e.g., AP2) or a first STA (e.g., STA1), respectively, in a wireless network such as a WLAN in accordance with one or more of IEEE 802.11 standards. Process 1100 may begin at block 1110.

At 1110, process 1100 may involve processor 922 of apparatus 920, as a first STA associated with a first AP (e.g., apparatus 910), communicating, via transceiver 926, with the first AP in a MAP system comprising the first AP and a second AP with which a second STA is associated. The first AP is the first STA's direct AP and the second STA's interfering AP, and the second AP is the second STA's direct AP and the first STA's interfering AP. Process 1100 may proceed from 1110 to 1120.

At 1120, process 1100 may involve processor 922 participating, via transceiver 926, in one or more coordinated operations with at least the first AP to reduce CSI feedback overhead. The one or more operations involve at least one of: (a) utilizing uneven sounding intervals at the interfering APs; (b) utilizing uneven fixed SC grouping at the interfering APs; and (c) utilizing adaptive SC grouping.

In some implementations: (a) the utilizing of the uneven sounding intervals at the interfering APs may involve each interfering AP utilizing a different and longer sounding interval than that used by each direct AP; (b) the utilizing of the uneven fixed SC grouping at the interfering APs may involve each interfering AP utilizing a different and larger SC grouping size than that used by each direct AP; and (c) the utilizing of the adaptive SC grouping may involve each AP utilizing inter-SC correlation coefficients by using A-SCG to select several contiguous SCs that are correlated sufficiently closely to be represented by a same CSI.

In some implementations, in participating in the one or more coordinated operations, process 1100 may involve processor 922 receiving an announcement frame (e.g., NDPA frame) from the first AP with an indication of whether an A-SCG capability is enabled. For instance, the indication may include one of a plurality of reserved bits in the announcement frame serving as a 1-bit flag to provide the indication.

In some implementations, in participating in the one or more coordinated operations, process 1100 may involve processor 922 transmitting a compressed beamforming frame to the first AP with an A-SCG flag in the compressed beamforming frame indicating that a CSI report is encoded using A-SCG. In some implementations, the compressed beamforming frame may also include an A-SCG Bitmap field of an A-SCG bitmap with each bit in the A-SCG bitmap representing a respective SC and with a position of each bit in the A-SCG bitmap representing a respective SC number. Moreover, the A-SCG bitmap may enable the first AP to reconstruct all per-SC CSIs.

In some implementations, in participating in the one or more coordinated operations, process 1100 may involve processor 922 transmitting a feedback to the first AP in a coordinated feedback frame or a reserved field in a response frame (e.g., Block ACK) characterizing a CIQ.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
communicating, by a processor of a first access point (AP) in a multi-AP (MAP) system, with a first station (STA) associated with the first AP and a second AP with which a second STA is associated; and
performing, by the processor, one or more coordinated operations with the second AP to reduce channel state information (CSI) feedback overhead,
wherein the first AP is the first STA's direct AP and the second STA's interfering AP,
wherein the second AP is the second STA's direct AP and the first STA's interfering AP, and
wherein the one or more operations involve at least one of:
utilizing uneven sounding intervals at the interfering APs;
utilizing uneven fixed subcarrier (SC) grouping at the interfering APs; and
utilizing adaptive SC grouping.

2. The method of claim 1, wherein the utilizing of the uneven sounding intervals at the interfering APs involves each interfering AP utilizing a different and longer sounding interval than that used by each direct AP.

3. The method of claim 1, wherein the utilizing of the uneven fixed SC grouping at the interfering APs involves each interfering AP utilizing a different and larger SC grouping size than that used by each direct AP.

4. The method of claim 1, wherein the utilizing of the adaptive SC grouping involves each AP utilizing inter-SC correlation coefficients by using adaptive SC grouping (A-SCG) to select several contiguous SCs that are correlated sufficiently closely to be represented by a same CSI.

5. The method of claim 1, wherein the performing of the one or more coordinated operations comprises:
increasing either or both of a sounding interval and a SC grouping size;
after a period of time, determining with the second AP about whether or not to increase or decrease the sounding interval or the SC grouping size; and
setting a new value of either or both of the sounding interval and the SC grouping size as a result of the determining.

6. The method of claim 1, wherein the performing of the one or more coordinated operations comprises transmitting an announcement frame with an indication of whether an adaptive SC grouping (A-SCG) capability is enabled.

7. The method of claim 6, wherein the indication comprises one of a plurality of reserved bits in the announcement frame serving as a 1-bit flag to provide the indication.

8. The method of claim 1, wherein the performing of the one or more coordinated operations comprises receiving a compressed beamforming frame from the first STA or the second STA with an adaptive SC grouping (A-SCG) flag in the compressed beamforming frame indicating that a CSI report is encoded using A-SCG.

9. The method of claim 8, wherein the compressed beamforming frame further comprises an A-SCG Bitmap field of an A-SCG bitmap with each bit in the A-SCG bitmap representing a respective SC and with a position of each bit in the A-SCG bitmap representing a respective SC number, and wherein the A-SCG bitmap enables the first AP to reconstruct all per-SC CSIs.

10. The method of claim 9, wherein:
a value of 0 in a bit of the A-SCG bitmap indicates that a corresponding SC belongs to a SC group starting with a first non-zero element to a left from a current bit position in the A-SCG bitmap, with all SCs in the SC group sharing a same CSI that is computed for the first non-zero element in the SC group; and
a value of 1 in another bit of the A-SCG bitmap indicates that a corresponding CSI for a respective SC is computed and represented in a beamforming report field, with the respective SC serving as a start of a SC feedback group.

11. The method of claim 1, wherein the performing of the one or more coordinated operations comprises:
computing one or more sounding parameters for CSI reporting;
exchanging the one or more sounding parameters with the second AP;
performing channel sounding;
performing a multi-user (MU) beamforming (BF) transmission;
collecting feedbacks from the first STA and the second STA regarding noise and interference power levels; and
coordinating with the second AP regarding an amount of a residual MU interference.

12. The method of claim 11, wherein the computing of the one or more sounding parameters comprises computing the one or more sounding parameters using partial or zero interference nulling precoding.

13. The method of claim 11, wherein the collecting of the feedbacks comprises receiving a feedback from the first STA or the second STA in a coordinated feedback frame or a reserved field in a response frame.

14. The method of claim 11, wherein the collecting of the feedbacks comprises receiving a feedback from the first STA or the second STA characterizing a channel interference quality (CIQ).

15. The method of claim 11, wherein the performing of the one or more coordinated operations further comprises:
determining, based on the feedbacks, whether a channel interference quality (CIQ) exceeds a threshold value per selected modulation and coding scheme (MCS);
re-computing the one or more sounding parameters responsive to a positive result from the determining; and
providing the re-computed one or more sounding parameters to the second AP to be used in coordinated beamforming (CBF).

16. A method, comprising:
communicating, by a processor of a first station (STA) associated with a first access point (AP), with the first AP in a multi-AP (MAP) system comprising the first AP and a second AP with which a second STA is associated; and
participating, by the processor, in one or more coordinated operations with at least the first AP to reduce channel state information (CSI) feedback overhead,
wherein the first AP is the first STA's direct AP and the second STA's interfering AP,
wherein the second AP is the second STA's direct AP and the first STA's interfering AP, and
wherein the one or more operations involve at least one of:
utilizing uneven sounding intervals at the interfering APs;
utilizing uneven fixed subcarrier (SC) grouping at the interfering APs; and
utilizing adaptive SC grouping.

17. The method of claim 16, wherein:
the utilizing of the uneven sounding intervals at the interfering APs involves each interfering AP utilizing a different and longer sounding interval than that used by each direct AP;
the utilizing of the uneven fixed SC grouping at the interfering APs involves each interfering AP utilizing a different and larger SC grouping size than that used by each direct AP; and
the utilizing of the adaptive SC grouping involves each AP utilizing inter-SC correlation coefficients by using adaptive SC grouping (A-SCG) to select several contiguous SCs that are correlated sufficiently closely to be represented by a same CSI.

18. The method of claim 16, wherein the participating in the one or more coordinated operations comprises receiving an announcement frame from the first AP with an indication of whether an adaptive SC grouping (A-SCG) capability is enabled, and wherein the indication comprises one of a plurality of reserved bits in the announcement frame serving as a 1-bit flag to provide the indication.

19. The method of claim 16, wherein the participating in the one or more coordinated operations comprises transmitting a compressed beamforming frame to the first AP with an adaptive SC grouping (A-SCG) flag in the compressed beamforming frame indicating that a CSI report is encoded using A-SCG, wherein the compressed beamforming frame further comprises an A-SCG Bitmap field of an A-SCG bitmap with each bit in the A-SCG bitmap representing a respective SC and with a position of each bit in the A-SCG bitmap representing a respective SC number, and wherein the A-SCG bitmap enables the first AP to reconstruct all per-SC CSIs.

20. The method of claim 16, wherein the participating in the one or more coordinated operations comprises transmitting a feedback to the first AP in a coordinated feedback frame or a reserved field in a response frame characterizing a channel interference quality (CIQ).
